(19) United States
(12) Patent Application Publication
(10) Pub. No.: US 2004/0256311 A1
(43) Pub. Date: Dec. 23, 2004

(54) Ultralyophobic membrane

(76) Inventor: Charles W. Extrand, Minneapolis, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/824,340

(22) Filed: Apr. 14, 2004

Related U.S. Application Data
(60) Provisional application No. 60/462,963, filed on Apr. 15, 2003.

(51) Int. Cl. B01D 69/00

(52) U.S. Cl. 210/500.21; 264/41

(57) ABSTRACT

A microporous gas permeable membrane having an ultraphobic liquid contact surface. In the invention, ultraphobic surface is provided on the liquid contact surface of the membrane. In an embodiment of the invention, the ultraphobic surface includes a multiplicity of closely spaced microscale to nanoscale asperities formed on a substrate. When liquid at or below a predetermined pressure value is contacted with the ultraphobic liquid contact surface of the membrane, the liquid is “suspended” at the tops of the asperities, defining a liquid/gas interface plane. The area of the liquid/gas interface plane includes the area of the ultraphobic surface as well as the combined area of the micropores, so that the gas transfer rate and efficiency of the membrane is enhanced over prior membranes wherein the liquid/gas interfacial area is limited to only the area of the micropores.

### RELATED APPLICATIONS

This application claims the benefit of U.S. Provisional Patent Application Ser. No. 60/462,963 entitled “Ultraphobic Surface for High Pressure Liquids”, filed Apr. 15, 2003, hereby fully incorporated herein by reference.

### FIELD OF THE INVENTION

The present invention relates generally to microporous membranes, and more particularly to a microporous membrane having an ultrahydrophobic or ultralyophobic surface thereon.

### BACKGROUND OF THE INVENTION

Microporous gas permeable membranes are widely used to effect mass transfer between a liquid and a gas. These membranes may take the form of a film or a hollow fiber. One common application of such a membrane is, for example, in blood oxygenation apparatus to achieve exchange of oxygen and carbon dioxide gas in blood circulating in a patient. Particular examples of blood oxygenation apparatus are disclosed in U.S. Pat. Nos. 3,794,468; 4,329,729; 4,374,802; and 4,659,549, each fully incorporated herein by reference. Other particular examples of uses for gas permeable membranes are discussed in U.S. Pat. No. 5,254,143, also fully incorporated herein by reference.

One example of a prior film type microporous membrane 200 is depicted in greatly enlarged cross-section in prior art FIG. 17. Membrane 200 generally includes membrane body 202 having a multiplicity of micropores 204 defined therein. Gas contact surface 206 confronts gas 208 on one side of membrane 200 while liquid contact surface 210 confronts liquid 212 on the other side of membrane 200. A liquid/gas interface plane 214 is defined at each micropore 204, having an area generally equal to the area of the micropore 204.

In the prior membranes discussed above, the interfacial liquid/gas area of prior membranes is limited to the cumulative area of the micropores 204. As a result, since the rate of gas transfer depends on the amount of interfacial liquid/gas area available in the membrane, the gas transfer rate and consequent efficiency of these prior membranes are limited. What is needed in the industry is microporous gas permeable membrane having improved gas transfer rate and efficiency.

### SUMMARY OF THE INVENTION

The present invention addresses the needs of the industry by providing a microporous gas permeable membrane having a liquid contact surface that defines a liquid/gas interface plane larger than the combined area of the micropores in the membrane. For the purpose of the present application, “microscale ” generally refers to dimensions of less than 100 micrometers, and “nanoscale” generally refers to dimensions of less than 100 nanometers. The surface is designed to maintain ultraphobic properties up to a certain predetermined pressure value. The asperities are disposed so that the surface has a predetermined contact line density measured in meters of contact line per square meter of surface area equal to or greater than a contact line density value “Λ_{L}” determined according to the formula:

$${Λ}_{L} = \frac{- P}{γ cos ( {θ}_{a , 0} + ω - {90}^{°} )}$$

where P is the predetermined pressure value, γ is the surface tension of the liquid, and θ_{a,0 is the experimentally measured true advancing contact angle of the liquid on the asperity material in degrees, and ω is the asperity rise angle. The predetermined pressure value may be selected so as to be greater than the anticipated liquid pressures expected to be encountered by the membrane.}

When liquid at or below the predetermined pressure value is contacted with the ultraphobic liquid contact surface of the membrane, the liquid is “suspended” at the tops of the asperities, defining a liquid/gas interface plane having an area equal to the total area of the ultraphobic surface less the combined cross-sectional area of the asperities. Gas introduced on the gas contact surface side of the membrane moves through the micropores in the membrane and into the space surrounding the asperities defined between the substrate of the ultraphobic surface and the liquid/gas interface plane. Since the area of the liquid/gas interface plane includes the area of the ultraphobic surface as well as the combined area of the micropores, the gas transfer rate and efficiency of the membrane may be greatly enhanced over prior membranes wherein the liquid/gas interfacial area is limited to only the area of the micropores. Generally, to maximize the amount of liquid/gas interface area available at the ultraphobic surface, and thus the gas transfer rate and efficiency of the membrane, it is desirable to minimize the contact line density of the surface while maintaining the predetermined pressure value at a level sufficient to provide ultraphobic properties at the maximum expected pressure to be encountered at the membrane.

The asperities may be formed in or on the substrate material itself or in one or more layers of material disposed on the surface of the substrate. The asperities may be any regularly or irregularly shaped three dimensional solid or cavity and may be disposed in any regular geometric pattern or randomly. The asperities may be formed using photolithography, or using nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, or by disposing a layer of parallel carbon nanotubes on the substrate.

The invention may also include a process for making a microporous gas permeable membrane with surfaces having ultraphobic properties at liquid pressures up to a predetermined pressure value. The process includes steps of selecting an asperity rise angle; determining a critical contact line density “Λ_{L}” value according to the formula:

$${Λ}_{L} = \frac{- P}{γ cos ( {θ}_{a , 0} + ω - {90}^{°} )}$$

where P is the predetermined pressure value, γ is the surface tension of the liquid, and θ_{a,0} is the experimentally measured true advancing contact angle of the liquid on the asperity material in degrees, and ω is the asperity rise angle; providing a carrier with a surface portion; and forming a multiplicity of projecting asperities on the surface portion so that the surface has an actual contact line density equal to or greater than the critical contact line density. Again, it is generally preferred to maximize the amount of liquid/gas interface area available at the ultraphobic surface by minimizing the contact line density of the surface while maintaining the predetermined pressure value at a level sufficient to provide ultraphobic properties at the maximum expected pressure to be encountered at the membrane.

The process may further include the step of determining a critical asperity height value “Z_{c}” in meters according to the formula:

$${Z}_{c} = \frac{d ( 1 - cos ( {θ}_{a , 0} + ω - {180}^{°} ) )}{2 sin ( {θ}_{a , 0} + ω - {180}^{°} )}$$

where d is the distance in meters between adjacent asperities, θ_{a,0} is the true advancing contact angle of the liquid on the surface in degrees, and ψ is the asperity rise angle in degrees.

### BRIEF DESCRIPTION OF THE DRAWINGS

FIG. 1a is a greatly enlarged cross-sectional view of a film membrane according to the present invention;

FIG. 1b is a greatly enlarged cross-sectional view of a hollow fiber membrane according to the present invention;

FIG. 1 is a perspective, greatly enlarged view of an ultraphobic surface, wherein a multiplicity of nano/micro scale asperities are arranged in a rectangular array;

FIG. 2 is a top plan view of a portion of the surface of FIG. 1;

FIG. 3 is a side elevation view of the surface portion depicted in FIG. 2;

FIG. 4 is a partial top plan view of an alternative embodiment of the present invention wherein the asperities are arranged in a hexagonal array;

FIG. 5 is a side elevation view of the alternative embodiment of FIG. 4;

FIG. 6 is a side elevation view depicting the deflection of liquid suspended between asperities;

FIG. 7 is a side elevation view depicting a quantity of liquid suspended atop asperities;

FIG. 8 is a side elevation view depicting the liquid contacting the bottom of the space between asperities;

FIG. 9 is a side elevation view of a single asperity in an alternative embodiment of the invention wherein the asperity rise angle is an acute angle;

FIG. 10 is a side elevation view of a single asperity in an alternative embodiment of the invention wherein the asperity rise angle is an obtuse angle;

FIG. 11 a partial top plan view of an alternative embodiment of the present invention wherein the asperities are cylindrical and are arranged in a rectangular array;

FIG. 12 is a side elevation view of the alternative embodiment of FIG. 11;

FIG. 13 is a table listing formulas for contact line density for a variety of asperity shapes and arrangements;

FIG. 14 is a side elevation view of an alternative embodiment of the present invention;

FIG. 15 is a top plan view of the alternative embodiment of FIG. 14;

FIG. 16 is a top plan view of a single asperity in an alternative embodiment of the present invention;

FIG. 17 is a greatly enlarged cross-sectional view of a prior art film type microporous membrane.

### DETAILED DESCRIPTION OF THE PREFERRED EMBODIMENTS

Surfaces resistant to wetting by liquids may be referred to as hydrophobic where the liquid is water, and lyophobic relative to other liquids. The surface may be generally referred to as an ultrahydrophobic or ultralyophobic surface if the surface resists wetting to an extent characterized by any or all of the following: very high advancing contact angles of liquid droplets with the surface (greater than about 120 degrees) coupled with low contact angle hysteresis values (less than about 20 degrees); a markedly reduced propensity of the surface to retain liquid droplets; or the presence of a liquid-gas-solid interface at the surface when the surface is completely submerged in liquid,. For the purposes of this application, the term ultraphobic is used to refer generally to both ultrahydrophobic and ultralyophobic surfaces. The term microporous membrane as used herein means a membrane having pores therein with a diameter between about.

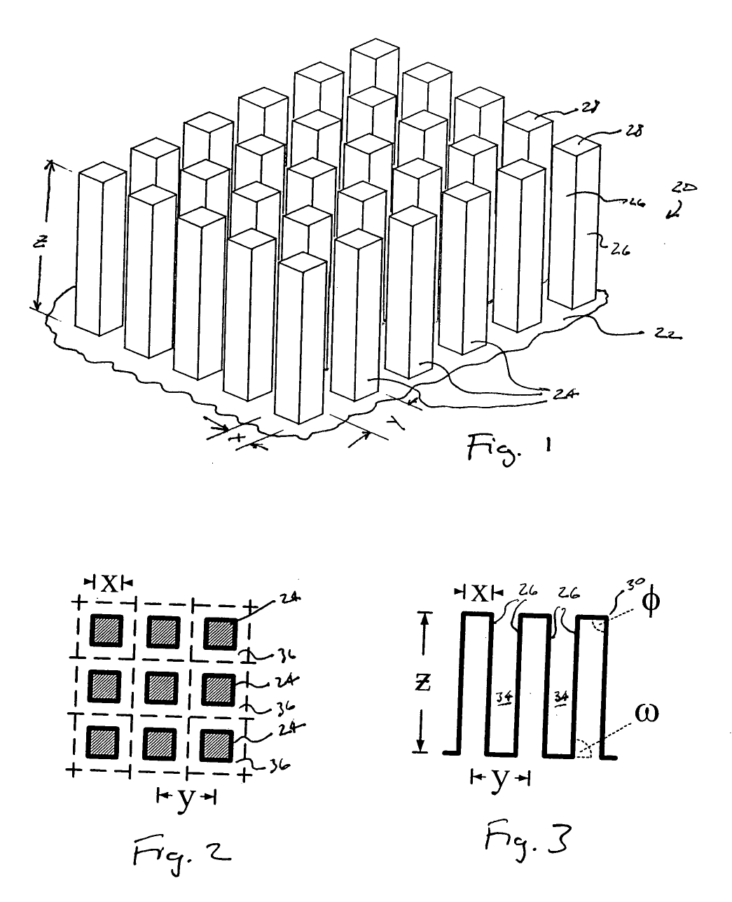

Referring to FIG. 1a, an embodiment of a microporous gas permeable film membrane 100 according to the invention is depicted in greatly enlarged cross-section. Membrane 100 generally includes a membrane body 102 made from polymer material with a multiplicity of micropores 104 defined therethrough. Micropores 104 preferably have a diameter of from about 0.005 μm to about 100 μm, and more preferably from about 0.01 μm to about 50 μm. Membrane 100 has a gas contact surface 106 on one side confronting gas 107 and a liquid contact surface 108 on the opposite side confronting liquid 109. According to the invention, an ultraphobic surface 20 is formed on liquid contact surface 106.

Another embodiment of a microporous gas permeable membrane 110 in the form of a hollow fiber is depicted in FIG. 1b. Membrane 110 generally includes tubular membrane body 112 of polymer material with a multiplicity of micropores 114 defined therethrough. Membrane 110 has a gas contact surface 116 on exterior surface 118 confronting gas 120 and a liquid contact surface 122 on interior surface 124 confronting liquid 126. According to the invention, an ultraphobic surface 20 is formed on liquid contact surface 116. It will be appreciated that the relative positions of gas contact surface 116 and liquid contact surface 122 may be reversed so that gas contact surface 116 is on interior surface 124 and liquid contact surface 122 is on exterior surface 118.

A greatly enlarged view of a preferred embodiment of ultraphobic surface 20 is depicted in FIG. 1. The surface 20 generally includes a substrate 22 with a multiplicity of projecting asperities 24. Each asperity 24 has a plurality of sides 26 and a top 28. Each asperity has a width dimension, annotated “x” in the figures, and a height dimension, annotated “z” in the figures.

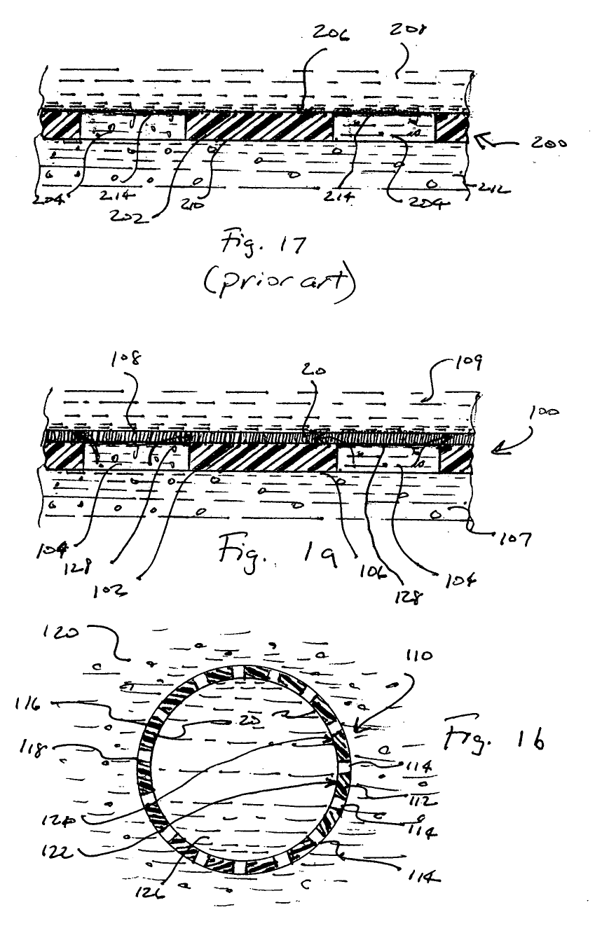

As depicted in FIGS. 1-3, asperities 24 are disposed in a regular rectangular array, each asperity spaced apart from the adjacent asperities by a spacing dimension, annotated “y” in the figures. The angle subtended by the top edge 30 of the asperities 24 is annotated φ, and the rise angle of the side 26 of the asperities 24 relative to the substrate 22 is annotated ω. The sum of the angles φ and ω is 180 degrees.

Generally, surface 20 will exhibit ultraphobic properties when a liquid-solid-gas interface is maintained at the surface. As depicted in FIG. 7, if liquid 32 contacts only the tops 28 and a portion of the sides 26 proximate top edge 30 of asperities 24, leaving a space 34 between the asperities filled with air or other gas, the requisite liquid-solid-gas interface is present. The liquid may be said to be “suspended” atop and between the top edges 30 of the asperities 24. As will be disclosed hereinbelow, the formation of the liquid-solid-gas interface depends on certain interrelated geometrical parameters of the asperities 24 and the properties of the liquid. According to the present invention, the geometrical properties of asperities 24 may be selected so that the surface 20 exhibits ultraphobic properties at any desired liquid pressure.

Referring to the rectangular array of FIGS. 1-3, surface 20 may be divided into uniform areas 36, depicted bounded by dashed lines, surrounding each asperity 24. The area density of asperities (6) in each uniform area 36 may be described by the equation:

$$δ = \frac{1}{2 {y}^{2}} , \qquad ( 1 )$$

where y is the spacing between asperities measured in meters.

For asperities 24 with a square cross-section as depicted in FIGS. 1-3, the length of perimeter (p) of top 28 at top edge 30:

p=4x, (2)

where x is the asperity width in meters.

Perimeter p may be referred to as a “contact line” defining the location of the liquid-solid-gas interface. The contact line density (λ) of the surface, which is the length of contact line per unit area of the surface, is the product of the perimeter (p) and the area density of asperities (δ) so that:

λ=pδ. (3)

For the rectangular array of square asperities depicted in FIGS. 1-3:

A=4x/y². (4)

A quantity of liquid will be suspended atop asperities 24 if the body forces (F) due to gravity acting on the liquid are less than surface forces (f) acting at the contact line with the asperities. Body forces (F) associated with gravity may be determined according to the following formula:

F=ρgh, (5)

where g is the density (ρ) of the liquid, (g) is the acceleration due to gravity, and (h) is the depth of the liquid. Thus, for example, for a 10 meter column of water having an approximate density of 1000 kg/m³, the body forces (F) would be:

F=(1000 kg/m³)(9.8 m/s ²)(10 m)=9.8 ×104 kg/m²−s.

On the other hand, the surface forces (f) depend on the surface tension of the liquid (γ), its apparent contact angle with the side 26 of the asperities 24 with respect to the vertical θ_{S}, the contact line density of the asperities (Λ) and the apparent contact area of the liquid (A):

f=−ΛAγcos θₛtm (6)

The true advancing contact angle (θ_{a,0}) of a liquid on a given solid material is defined as the largest experimentally measured stationary contact angle of the liquid on a surface of the material having essentially no asperities. The true advancing contact angle is readily measurable by techniques well known in the art.

Suspended drops on a surface with asperities exhibit their true advancing contact angle value (θ_{a,0}) at the sides of the asperities. The contact angle with respect to the vertical at the side of the asperities (θ_{s) is related to the true advancing contact angle (θ}_{a,0}) by φ or ω as follows:

θₛ=θ_{a,0}+90°−φ=θ_{a,0}+ω−90°. (7)

By equating F and f and solving for contact line density Λ, a critical contact line density parameter Λ_{L} may be determined for predicting ultraphobic properties in a surface:

$${Λ}_{L} = \frac{- ρ gh}{γ cos ( {θ}_{a , 0} + ω - {90}^{°} )} , \qquad ( 8 )$$

where g is the density (ρ) of the liquid, (g) is the acceleration due to gravity, (h) is the depth of the liquid, the surface tension of the liquid (γ), ω is the rise angle of the side of the asperities relative to the substrate in degrees, and (θ_{a,0}) is the experimentally measured true advancing contact angle of the liquid on the asperity material in degrees.

If Λ>Λ_{L}, the liquid will be suspended atop the asperities 24, producing an ultraphobic surface. Otherwise, if Λ<Λ_{L}, the liquid will collapse over the asperities and the contact interface at the surface will be solely liquid/solid, without ultraphobic properties.

It will be appreciated that by substituting an appropriate value in the numerator of the equation given above, a value of critical contact line density may be determined to design a surface that will retain ultraphobic properties at any desired amount of pressure. The equation may be generalized as:

$${Λ}_{L} = \frac{- P}{γ cos ( {θ}_{a , 0} + ω - {90}^{°} )} , \qquad ( 9 )$$

where P is the maximum pressure under which the surface must exhibit ultraphobic properties in kilograms per square meter, γ is the surface tension of the liquid in Newtons per meter, θ_{a,0} is the experimentally measured true advancing contact angle of the liquid on the asperity material in degrees, and ω is the asperity rise angle in degrees.

It is generally anticipated that a surface 20 formed according to the above relations will exhibit ultraphobic properties under any liquid pressure values up to and including the value of P used in equation (9) above. The ultraphobic properties will be exhibited whether the surface is submerged, subjected to a jet or spray of liquid, or impacted with individual droplets. It will be readily appreciated that the pressure value P may be selected so as to be greater than the largest anticipated liquid pressure to which the membrane 100, 110, will be subjected. It will be generally appreciated that the value of P should be selected so as to provide an appropriate safety factor to account for pressures that may be momentarily or locally higher than anticipated, discontinuities in the surface due to tolerance variations, and other such factors.

Once the value of critical contact line density is determined, the remaining details of the geometry of the asperities may be determined according to the relationship of x and y given in the equation for contact line density (Λ). In other words, the geometry of the surface may be determined by choosing the value of either x or y in the contact line equation and solving for the other variable.

The liquid interface deflects downwardly between adjacent asperities by an amount D₁ as depicted in FIG. 6. If the amount D₁ is greater than the height (z) of the asperities 24, the liquid will contact the substrate 22 at a point between the asperities 24. If this occurs, the liquid will be drawn into space 34, and collapse over the asperities, destroying the ultraphobic character of the surface. The value of D₁ represents a critical asperity height (Z_{c}), and is determinable according to the following formula:

$${D}_{1} = {Z}_{c} = \frac{d ( 1 - cos ( {θ}_{a , 0} + ω - {180}^{°} ) )}{2 sin ( {θ}_{a , 0} + ω - {180}^{°} )} , \qquad ( 10 )$$

where (d) is the distance between adjacent asperities, ω is the asperity rise angle, and θ_{a,0} is the experimentally measured true advancing contact angle of the liquid on the asperity material. The height (z) of asperities 24 must be at least equal to, and is preferably greater than, critical asperity height (Z_{c}).

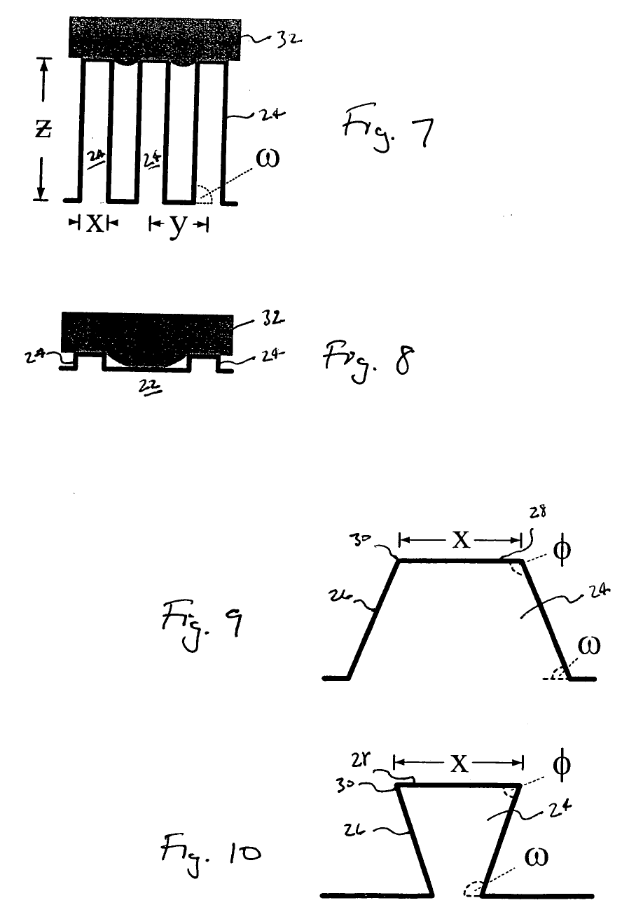

Although in FIGS. 1-3 the asperity rise angle ω is 90 degrees, other asperity geometries are possible. For example, ω may be an acute angle as depicted in FIG. 9 or an obtuse angle as depicted in FIG. 10. Generally, it is preferred that ω be between 80 and 130 degrees.

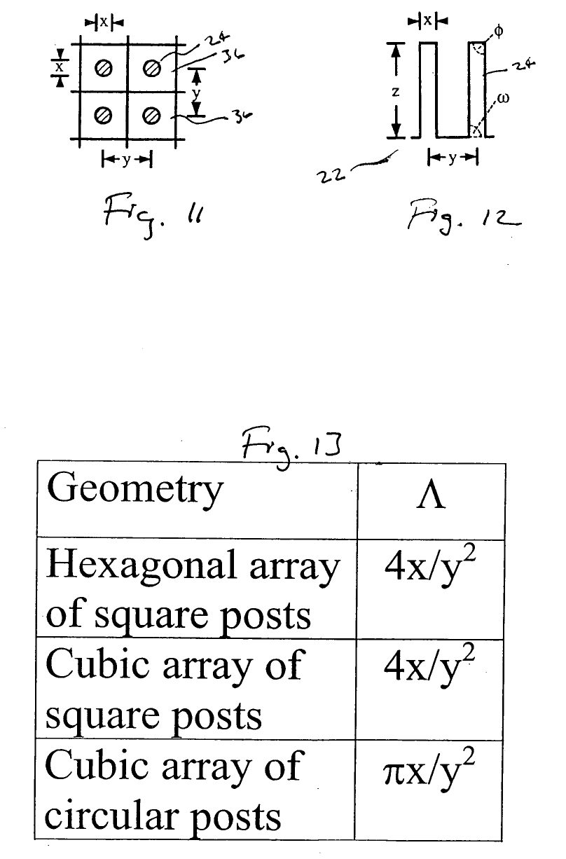

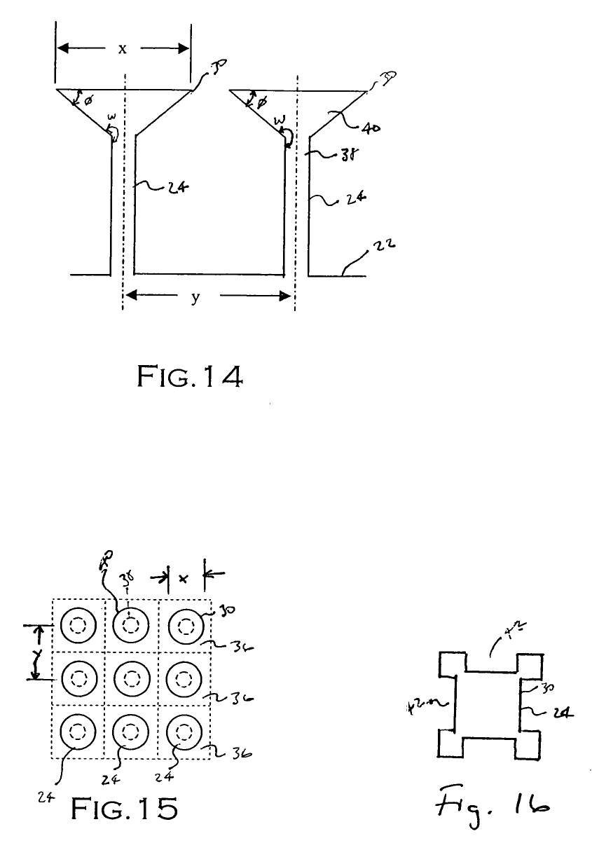

It will also be appreciated that a wide variety of asperity shapes and arrangements are possible within the scope of the present invention. For example, asperities may be polyhedral, cylindrical as depicted in FIGS. 1-12, cylindroid, or any other suitable three dimensional shape. In addition, various strategies may be utilized to maximize contact line density of the asperities. As depicted in FIGS. 14 and 15, the asperities 24 may be formed with a base portion 38 and a head portion 40. The larger perimeter of head portion 40 at top edge 30 increases the contact line density of the surface. Also, features such as recesses 42 may be formed in the asperities 24 as depicted in FIG. 16 to increase the perimeter at top edge 30, thereby increasing contact line density. The asperities may also be cavities formed in the substrate.

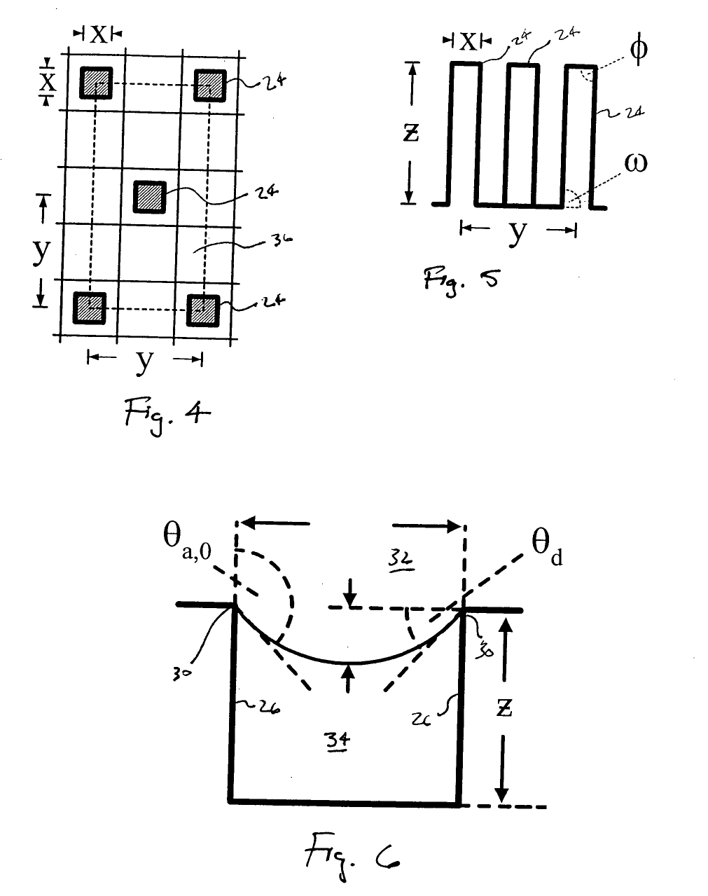

The asperities may be arranged in a rectangular array as discussed above, in a polygonal array such as the hexagonal array depicted in FIGS. 4-5, or a circular or ovoid arrangement. The asperities may also be randomly distributed so long as the critical contact line density is maintained, although such a random arrangement may have less predictable ultraphobic properties, and is therefore less preferred. In such a random arrangement of asperities, the critical contact line density and other relevant parameters may be conceptualized as averages for the surface. In the table of FIG. 13, formulas for calculating contact line densities for various other asperity shapes and arrangements are listed.

Generally, the material used for membrane body 102 may be any material upon which micro or nano scale asperities may be suitably formed and which is suitable for use in the processing environment in which the membrane is used. Specific examples of microporous membrane structures for which the present invention may be suitable are disclosed in U.S. Pat. Nos. 3,801,404; 4,138,459; 4,405,688; 4,664,681; 5,013,439; and 6,540,953, each hereby fully incorporated herein by reference.

The asperities may be formed directly in membrane body 102 itself, or in one or more layers of other material deposited thereon, by photolithography or any of a variety of suitable methods. A photolithography method that may be suitable for forming micro/nanoscale asperities is disclosed in PCT Patent Application Publication WO 02/084340, hereby fully incorporated herein by reference.

Other methods that may be suitable for forming asperities of the desired shape and spacing include nanomachining as disclosed in U.S. Patent Application Publication No. 2002/00334879, microstamping as disclosed in U.S. Pat. No. 5,725,788, microcontact printing as disclosed in U.S. Pat. No. 5,900,160, self-assembled metal colloid monolayers, as disclosed in U.S. Pat. No. 5,609,907, microstamping as disclosed in U.S. Pat. No. 6,444,254, atomic force microscopy nanomachining as disclosed in U.S. Pat. No. 5,252,835, nanomachining as disclosed in U.S. Pat. No. 6,403,388, sol-gel molding as disclosed in U.S. Pat. No. 6,530,554, self-assembled monolayer directed patterning of surfaces, as disclosed in U.S. Pat. No. 6,518,168, chemical etching as disclosed in U.S. Pat. No. 6,541,389, or sol-gel stamping as disclosed in U.S. Patent Application Publication No. 2003/0047822, all of which are hereby fully incorporated herein by reference. Carbon nanotube structures may also be usable to form the desired asperity geometries. Examples of carbon nanotube structures are disclosed in U.S. Patent Application Publication Nos. 2002/0098135 and 2002/0136683, also hereby fully incorporated herein by reference. Also, suitable asperity structures may be formed using known methods of printing with colloidal inks. Of course, it will be appreciated that any other method by which micro/nanoscale asperities may be formed with the requisite degree of precision may also be used. Further details generally relating to ultraphobic surfaces according to the invention may be found in U.S. patent application Serial Nos. 10/454,740; 10/454,742; 10/454,743; 10/454,745; 10/652,586; and 10/662,979; all owned by the owners of the present invention and hereby fully incorporated herein by reference.

Turning now to FIG. 1a, the operation of membrane 100, 110, may be understood. Liquid 109, which has a pressure at or below the maximum pressure (P) under which the surface must exhibit ultraphobic properties, is contacted with liquid contact surface 108 and is suspended on ultraphobic surface 20 atop and between the top edges 30 of the asperities 24 defining a liquid/gas interface plane 128. Liquid/gas interface plane 128 has an area equal to the area of ultraphobic surface 20, less the combined cross-sectional area of asperities 24. Gas 107 is introduced on the gas contact surface 106 side of membrane 100 and, as depicted by the arrows, moves through micropores 104 into the space defined between substrate 22 and the suspended liquid 109 so as to confront liquid 109 at liquid/gas interface plane 128. As will be appreciated, the total area of liquid/gas interface of membrane 100, 110, is the area of liquid/gas interface plane 128 plus the area of micropores 104.

The membrane 100, 110, may offer significantly improved gas transfer rates and efficiencies over prior art microporous membranes due to the increased available liquid/gas interfacial area. Further, the ultraphobic surface may be less prone to clogging or fouling due to liquid impuries or biofilm growth.

The present invention may be embodied in other specific forms without departing from the spirit or essential attributes thereof, and it is, therefore, desired that the present embodiment be considered in all respects as illustrative and not restrictive.

What is claimed is:

1. A microporous membrane comprising:
a membrane body portion having a multiplicity of micropores defined therethrough, the membrane body portion having a liquid contact surface and an opposing gas contact surface, the liquid contact surface having an ultraphobic surface thereon including a substrate with a multiplicity of substantially uniformly shaped asperities, each asperity having a common asperity rise angle relative to the substrate, the asperities positioned so that the ultraphobic surface defines a contact line density measured in meters of contact line per square meter of surface area equal to or greater than a contact line density value “Λ_{L}” determined according to the formula:
$${Λ}_{L} = \frac{- P}{γ cos ( {θ}_{a , 0} + ω - {90}^{°} )}$$
where γ is the surface tension of a liquid in contact with the surface in newtons per meter, θ_{a,0} is the experimentally measured true advancing contact angle of the liquid on the asperity material in degrees, ω is the asperity rise angle in degrees, and P is a predetermined liquid pressure value in kilograms per meter, so that when liquid at a liquid pressure up to and including the predetermined liquid pressure value is contacted with the ultraphobic surface, the liquid defines a liquid/gas interface plane spaced apart from the substrate:

2. The membrane of claim 1, wherein the membrane is a film.

3. The membrane of claim 1, wherein the membrane is a fiber.

4. The membrane of claim 1, wherein the asperities are projections.

5. The membrane of claim 4 wherein the asperities are polyhedrally shaped.

6. The membrane of claim 4 wherein each asperity has a generally square transverse cross-section.

7. The membrane of claim 4, wherein the asperities are cylindrical or cylindroidally shaped.

8. The membrane of claim 1, wherein the asperities are positioned in a substantially uniform array.

9. The membrane of claim 8, wherein the asperities are positioned in a rectangular array.

10. The membrane of claim 1, wherein the asperities have a substantially uniform asperity height relative to the substrate portion, and wherein the asperity height is greater than a critical asperity height value “Z_{c} ” in meters determined according to the formula:
$${Z}_{c} = \frac{d ( 1 - cos ( {θ}_{a , 0} + ω - {180}^{°} ) )}{2 sin ( {θ}_{a , 0} + ω - {180}^{°} )}$$
where d is the distance in meters between adjacent asperities, θ_{a,0} is the experimentally measured true advancing contact angle of the liquid on the asperity material in degrees, and ω is the asperity rise angle in degrees.

11. A process of making a microporous membrane with an ultraphobic liquid contact surface, the process comprising:
providing a microporous membrane having a membrane body portion with a multiplicity of micropores defined therein, the membrane body portion having a first surface; and
forming an ultraphobic liquid contact surface on the first surface, the ultraphobic surface including a substrate with a multiplicity of substantially uniformly shaped asperities, each asperity having a common asperity rise angle relative to the substrate, the asperities positioned so that the ultraphobic surface has a contact line density measured in meters of contact line per square meter of surface area equal to or greater than a contact line density value “Λ_{L}” determined according to the formula:
$${Λ}_{L} = \frac{- P}{γ cos ( {θ}_{a , 0} + ω - {90}^{°} )}$$
where y is the surface tension of a liquid in contact with the surface in Newtons per meter, θ_{a,0} is the experimentally measured true advancing contact angle of the liquid on the asperity material in degrees, ω is the asperity rise angle in degrees, and P is a predetermined liquid pressure value in kilograms per meter, so that when liquid at a liquid pressure up to and including the predetermined liquid pressure value is contacted with the ultraphobic surface, the liquid defines a liquid/gas interface plane spaced apart from the substrate.

12. The process of claim 11, wherein the asperities are formed by a process selected from the group consisting of nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, and disposing a layer of parallel carbon nanotubes on the substrate.

13. The process of claim 11, wherein the process further comprises the step of determining a minimum contact line density.

14. A process for producing a microporous membrane having a liquid contact surface with ultraphobic properties at liquid pressures up to a predetermined pressure value, the process comprising:
selecting an asperity rise angle;
determining a critical contact line density “Λ_{L}” value according to the formula:
$${Λ}_{L} = \frac{- P}{γ cos ( {θ}_{a , 0} + ω - 90 ° )}$$
where P is the predetermined pressure value, γ is the surface tension of the liquid, θ_{a,0} is the experimentally measured true advancing contact angle of the liquid on the asperity material in degrees, and ω is the asperity rise angle;
providing a membrane body portion with a multiplicity of micropores defined therein;
and
forming an ultraphobic surface on the membrane body portion, the ultraphobic surface comprising a substrate with a multiplicity of projecting asperities, the asperities disposed so that the surface has an actual contact line density equal to or greater than the critical contact line density.

15. The process of claim 14, wherein the asperities are formed using nanomachining, microstamping, microcontact printing, self-assembling metal colloid monolayers, atomic force microscopy nanomachining, sol-gel molding, self-assembled monolayer directed patterning, chemical etching, sol-gel stamping, printing with colloidal inks, or by disposing a layer of parallel carbon nanotubes on the substrate.

16. The process of claim 14, further comprising the step of selecting a geometrical shape for the asperities.

17. The process of claim 14, further comprising the step of selecting an array pattern for the asperities.

18. The process of claim 14, further comprising the steps of selecting at least one dimension for the asperities and determining at least one other dimension for the asperities using an equation for contact line density.

19. The process of claim 18, further comprising the step of determining a minimum contact line density.

20. The process of claim 14, further comprising the step of determining a critical asperity height value “Z_{c}” in meters according to the formula:
$${Z}_{c} = \frac{d ( 1 - cos ( {θ}_{a , 0} + ω - 180 ° ) )}{2 sin ( {θ}_{a , 0} + ω - 180 ° )}$$
where d is the distance in meters between adjacent asperities, θ_{a,0} is the true advancing contact angle of the liquid on the surface in degrees, and ω is the asperity rise angle in degrees.
